(19) United States
(12) Patent Application Publication
(10) Pub. No.: US 2008/0230577 A1
(43) Pub. Date: Sep. 25, 2008

(54) BOOT HOLDER ASSEMBLY FOR A TRUCK, AND CORRESPONDING METHOD FOR STORING BOOTS

(76) Inventor: Gerald A. GARD, Mount Dora, FL (US)

Correspondence Address: MICHAEL W. TAYLOR, P.O. BOX 3791, ORLANDO, FL, 32802-3791, US

(21) Appl. No.: 12/034,738

(22) Filed: Feb. 21, 2008

Related U.S. Application Data
(60) Provisional application No. 60/895,804, filed on Mar. 20, 2007.

(51) Int. Cl. B60R 7/08

(52) U.S. Cl. 224/42.32

(57) ABSTRACT

A boot holder assembly for a truck includes a mounting plate to be positioned on an outer surface of a mounting area of the truck, with the mounting plate including openings extending therethrough. A reinforcement plate is to be positioned on an inner surface of the mounting area of the truck, and includes openings therein. Fasteners secure the mounting plate and the reinforcement plate to the mounting area of the truck via the respective openings, with each fastener including a shoulder extending outwardly from the mounting plate. A removable rack includes a base plate with slotted openings extending therethrough. The base plate is to be slideably positioned adjacent the mounting plate so that the slotted openings rest on the shoulders of the fasteners.

### RELATED APPLICATION

This application claims the benefit of U.S. Provisional Application Ser. No. 60/895,804 filed Mar. 20, 2007, the entire contents of which are incorporated herein by reference.

### FIELD OF THE INVENTION

The present invention relates to bot holders, and more particularly, to a boot holder assembly for the bed area of a pick-up truck.

### BACKGROUND OF THE INVENTION

Workers in construction, industrial, agricultural and various other industries typically use boots on the job. These work boots need to be cleaned, stored and transported on a daily basis in between being used. As an example, rubber boots are commonly used by concrete construction workers. When concrete construction workers complete a job, their rubber boots are hosed down and then typically thrown into the bed area of their work or pick-up trucks. When this happens, the inside of the rubber boots may not adequately dry out before the next job, particularly if the boots are exposed to rain.

In addition, the rubber boots are typically not secured when placed in the bed area of a pick-up truck. The rubber boots are susceptible to being damaged when heavier and bulkier items are placed in the bed area of the pick-up truck.

One approach for storing rubber boots in the bed area of a pick-up truck is disclosed in U.S. Pat. No. 6,012,592. The disclosed boot holder assembly comprises a base member to be positioned adjacent a side wall of the bed area of a pick-up truck. Boot receiving prongs are attached to the base member for receiving the work boots. A pair of outer support members is attached to the base member, and a top member is coupled between the pair of outer support members. The top member extends along an upper lip of the side wall of the bed area for firmly holding the boot holder assembly in place. While effective for storing work boots in the bed area of a pick-up truck, there is still a need for improving how boots are stored.

### SUMMARY OF THE INVENTION

In view of the foregoing background, it is therefore an object of the present invention to provide a boot holder assembly for the bed area of a pick-up truck.

This and other objects, features, and advantages in accordance with the present invention are provided by a boot holder assembly to be secured to a tool box in the bed area of a truck. The boot holder assembly may comprise a mounting plate to be positioned on an outer surface of the tool box, and includes openings extending therethrough. A reinforcement plate may be positioned on an inner surface of the tool box, and also includes openings therein. Fasteners may be used for securing the mounting plate and the reinforcement plate to the tool box via the plurality of respective openings. Each fastener may comprise a shoulder extending outwardly from the mounting plate. A removable rack may comprise a base plate with slotted openings extending therethrough, with the base plate being slideably positioned adjacent the mounting plate so that the slotted openings rest on the shoulders of the fasteners.

The boot rack assembly advantageously allows work boots to be stored in the bed area of a truck without having to be placed directly on the bottom of the bed area. This allows for easy storage and retrieval of the boots while standing on the ground next to the truck. In addition, items stored in the bed area, which can shift during movement of the truck, are now less likely to come in contact with the work boots.

The removable rack may comprise spaced apart dividers extending outwardly from the base plate, with each pair of adjacent dividers for receiving a boot. A spacing between each pair of adjacent dividers may be less than a width of the received boot for holding the boot. The removable rack may further comprise a cross member coupled to ends of the spaced apart dividers, with each boot being received so that a heel area thereof is adjacent the base plate and a toe area thereof rests on the cross member.

Each fastener may further comprise a head adjacent the shoulder, with the head being larger than the shoulder. Each slotted opening extends through the base plate and includes a first opening portion for receiving the head of a fastener, and a second slotted opening portion for being slideably positioned on the shoulder of the fastener. A width of the second slotted opening portion may be less than a width of the first opening portion.

The fasteners may comprise threaded fasteners. The openings in the reinforcement plate may be threaded for receiving the threaded fasteners. Alternatively, the openings in the reinforcement plate may extend therethrough for receiving the threaded fasteners, and threaded nuts are used for securing the fasteners. As an alternative to securing the boot holder assembly, the boot holder assembly may be secured to a mounting area in the bed area of the truck other than to the tool box. Consequently, the reinforcement plate may not be needed.

Another aspect of the invention is directed to a method for storing boots in the bed area of a truck using a boot holder assembly as described above. The method may comprise positioning the mounting plate on an outer surface of a tool box in the bed area of the truck, with the mounting plate including openings extending therethrough. The method may further comprise positioning the reinforcement plate on an inner surface of the tool box. The reinforcement plate may include openings therein. The mounting plate and the reinforcement plate may be secured to the tool box via the respective openings, with each fastener comprising a shoulder extending outwardly from the mounting plate. The removable rack may be slideably positioned adjacent the mounting plate. The removable rack may comprise a base plate with slotted openings extending therethrough, with the base plate being slideably positioned so that the slotted openings rest on the shoulders of the fasteners.

### BRIEF DESCRIPTION OF THE DRAWINGS

FIG. 1 is a perspective view of a boot holder assembly secured to a toolbox in the bed area of a pick-up truck in accordance with the present invention.

FIG. 2 is perspective view of the different components of the boot holder assembly in accordance with the present invention.

FIG. 3 is a side view of the boot rack assembly with a boot positioned therein in accordance with the present invention.

FIG. 4 is side view of the removable rack prior to being slideably positioned onto the shoulders of the fasteners in accordance with the present invention.

FIG. 5 is side view of the removable rack illustrated in FIG. 4 after having been slideably positioned onto the shoulders of the fasteners.

FIG. 6 is a perspective view of the removable rack configured for more than one pair of boots in accordance with the present invention.

FIG. 7 is another embodiment of the boot holder assembly in accordance with the present invention.

FIG. 8 is the boot holder assembly shown in FIG. 7 secured in the bed area of a pick-up truck.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

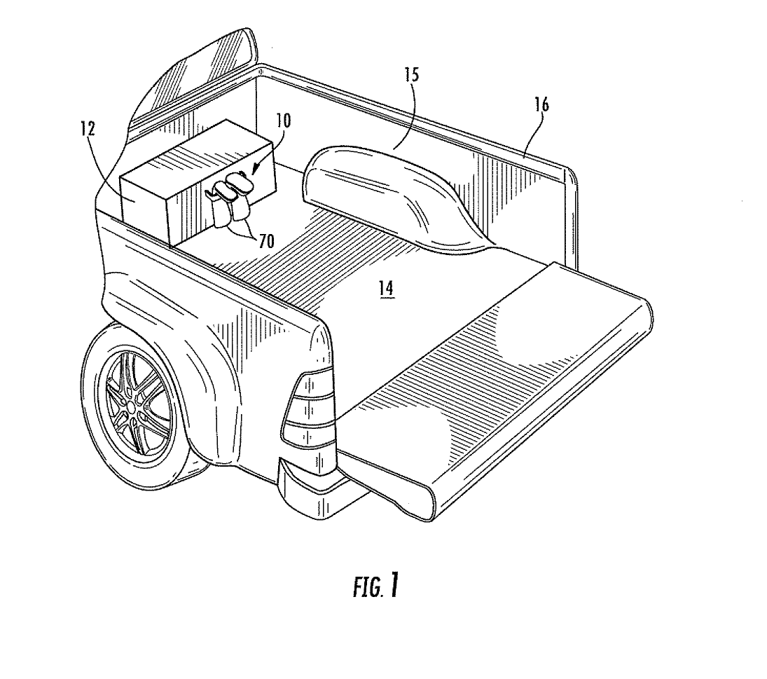

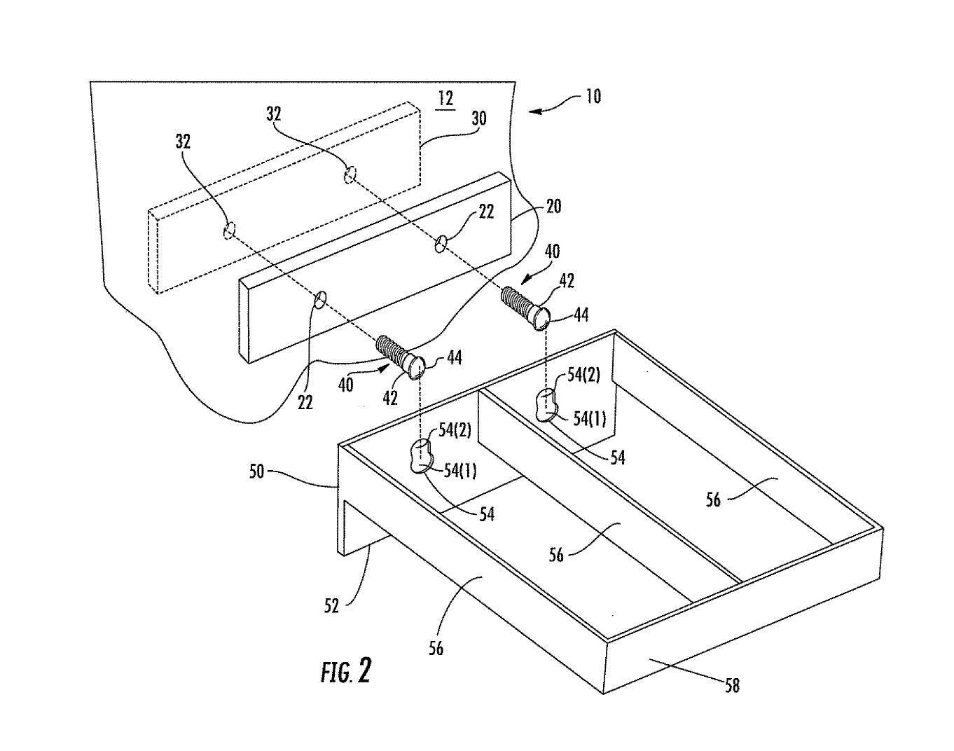

Referring now to FIGS. 1-3, a boot holder assembly 10 to be secured to a tool box 12 in the bed area 14 of a pick-up truck 16 will now be discussed. The boot holder assembly 10 comprises a mounting plate 20 to be positioned on an outer surface of the tool box 12, and includes openings 22 extending therethrough. A reinforcement plate 30 is to be positioned on an inner surface of the tool box 12, and includes openings therein 32.

Fasteners 40 are used for securing the mounting plate 20 and the reinforcement plate 30 to the tool box 12 via the plurality of their respective openings 22 and 32. Each fastener 40 comprises a shoulder 42 extending outwardly from the mounting plate 20. A removable rack 50 comprises a base plate 52 with slotted openings 54 extending therethrough. The base plate 52 is to be slideably positioned adjacent the mounting plate 20 so that the slotted openings 54 rest on the shoulders 42 of the fasteners 40.

The boot rack assembly 10 advantageously allows work boots 70 to be stored in the bed area 14 of a pick-up truck 16. This allows for easy storage and retrieval of the boots 70 while standing on the ground next to the truck 16. In addition, items stored in the bed area, which can shift during movement of the truck, are now less likely to come in contact with the work boots.

As an alternative, the boot rack assembly 10 may be mounted to a mounting area other than the tool box 12, as will be readily appreciated by those skilled in the art. The mounting area may be on a wall 15 of the bead area 14, for example. Consequently, the reinforcement plate 30 may not be needed or required.

The removable rack 50 comprises spaced apart dividers 56 extending outwardly from the base plate 52. Each pair of adjacent dividers 56 is for receiving a boot 70. A spacing between each pair of adjacent dividers 56 is preferably less than a width of the received boot 70. Since the boots 70 are typically water resistant, they are flexible and easily inserted between a pair of adjacent dividers 56.

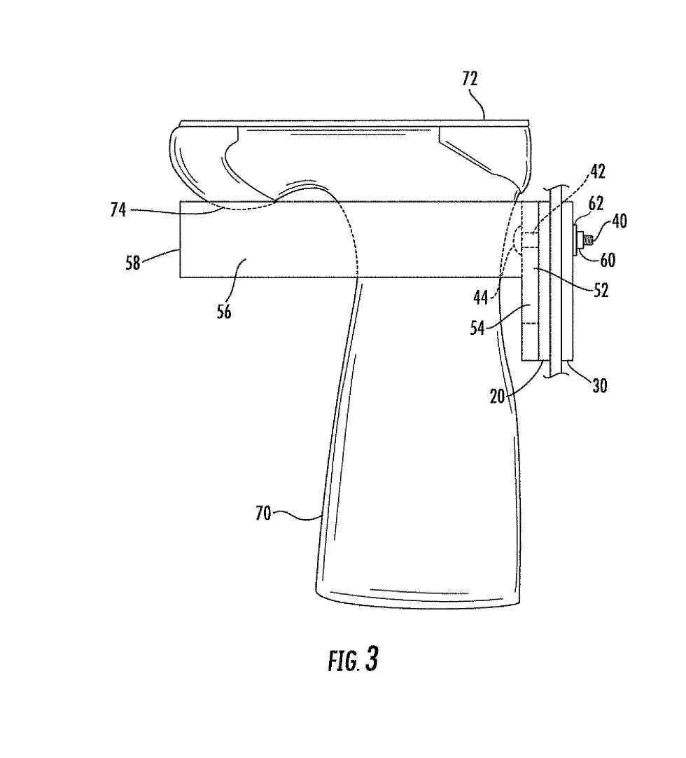

The removable rack 50 further comprises a cross member 58 coupled to ends of the spaced apart dividers 56. Each boot 70 is received therein so that a heel area 72 thereof is adjacent the base plate 52, and a toe area 74 thereof rests on the cross member 58, as best illustrated in FIG. 3.

Each fastener 40 further comprises a head 44 adjacent the shoulder 42. The head 44 is larger than the shoulder 42, i.e., it extends outwards past the shoulder. Each slotted opening 54 extending through the base plate 52 includes a first opening portion 54(1) for receiving the head 44 of a fastener 40, and a second slotted opening portion 54(2) for being slideably positioned on the shoulder 42 of the fastener 40. A width of the second slotted opening portion 54(2) is less than a width of the first opening portion 54(1).

Each illustrated fastener 40 is a threaded fastener. In one embodiment, the openings 32 in the reinforcement plate 30 are threaded for securing the threaded fasteners 40. In another embodiment, the openings in the reinforcement plate 30 extend therethrough so that nuts 60 are used for securing the fasteners 40. One or more washers 62 may be used between each nut 60 and the reinforcement plate 30. Similarly, rubber washers may be used between the mounting plate 20 and the tool box 12, and between the reinforcement plate 30 and the tool box 12. Although threaded fasteners 40 are illustrated, other types of fasteners for securing the boot rack assembly 10 in the bed area 14 of the pick-up truck 16 may be used, as will be readily appreciated by those skilled in the art.

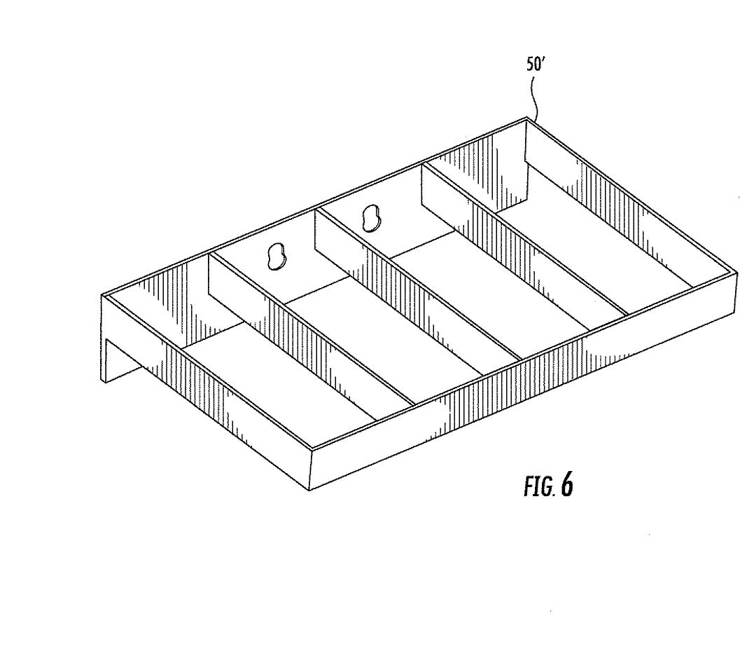

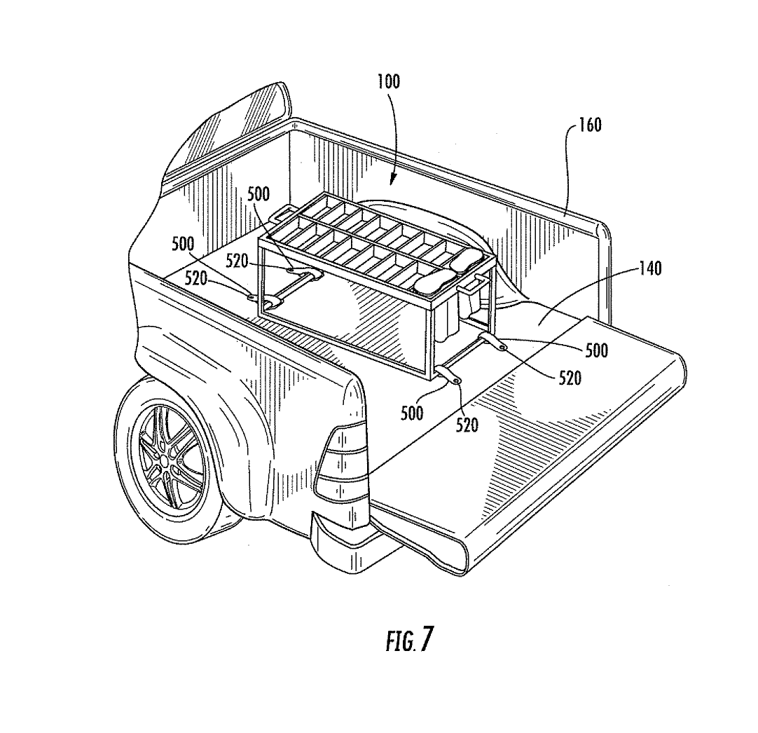

Referring now to FIGS. 5 and 6, slideably positioning the removable rack 50 onto the shoulders 42 of the fasteners 40 will now be discussed. The removable rack 50 is first aligned so that the first opening portions 54(1) of the slotted openings 54 are aligned to fit over the heads 44 of the fasteners 40. The removable rack 50 is moved so that a back side of the base plate 52 contacts the mounting plate 20. Next, the movable rack 50 is pushed downwards so that the second slotted opening portions 54(2) engage the shoulders 42 of the fasteners 40. The head 44 of the fastener 40 pushes against a front side of the base plate 52.

The illustrated removable rack is sized for a single pair of boots 70. As will be readily appreciated by those skilled in the art, the removable rack 50 can be sized to hold more than one pair of boots 70. For example, the removable rack 50′ illustrated in FIG. 6 holds a pair of boots 70. Nonetheless, the removable rack 50 can be sized to hold more than two pairs of boots 70.

The boot holder assembly 10 can be fabricated out of different types of materials. For example, the boot holder assembly 10 may be made out of steel or aluminum, for example. Of course, other types or metals may be used. Alternatively, the boot holder assembly 10 may be made out of a high strength poly resin material, such as plastic. The boot holder assembly 10 may even be fabricated out of a combination of metals and plastics, for example.

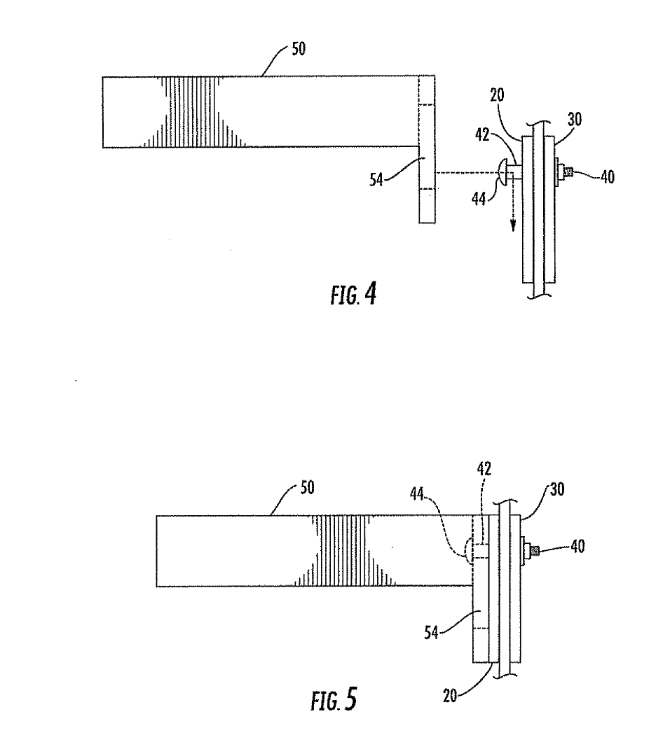

For the embodiment illustrated in FIGS. 1-5, the mounting plate 20 may be 1 by 5 inches, with the mounting holes 22 being spaced within a range of about 2 to 2.5 inches apart, for example. The reinforcement plate 30 is similarly sized.

The length or width of the shoulders 42 of the fasteners 40 is sized slightly larger than the width of the base plate 52 of the removable rack 50. The length or width of the shoulders 42 may be about 0.25 inches, for example. The arms 56 extend outward within a range of about 6 to 10 inches, with a width between adjacent arms 56 being within a range of about 2 to 3 inches, for example. These dimensions are for illustrative purposes, and vary depending on the intended application of the boot holder assembly 10.

A method for storing boots 70 in the bed area 14 of a truck 16 using a boot holder assembly 10 comprising a mounting plate 20, a reinforcement plate 30, a plurality of fasteners 40 and a removable rack 50 will now be discussed. The method comprises positioning the mounting plate 20 on an outer surface of a tool box 12 in the bed area 14 of the truck 16, with the mounting plate 20 including a plurality of openings 22 extending therethrough.

The method further comprises positioning the reinforcement plate 30 on an inner surface of the tool box 12. The reinforcement plate 30 includes a plurality of openings 32 therein. The mounting plate 20 and the reinforcement plate 30 are secured to the tool box 12 via the plurality of respective openings 22 and 32, with each fastener 40 comprising a shoulder 42 extending outwardly from the mounting plate 20. The removable rack 50 is slideably positioned adjacent the mounting plate 20. The removable rack 50 comprises a base plate 52 with a plurality of slotted openings 54 extending therethrough, with the base plate 52 being slideably positioned so that the plurality of slotted openings 54 rests on the shoulders 44 of the plurality of fasteners 40.

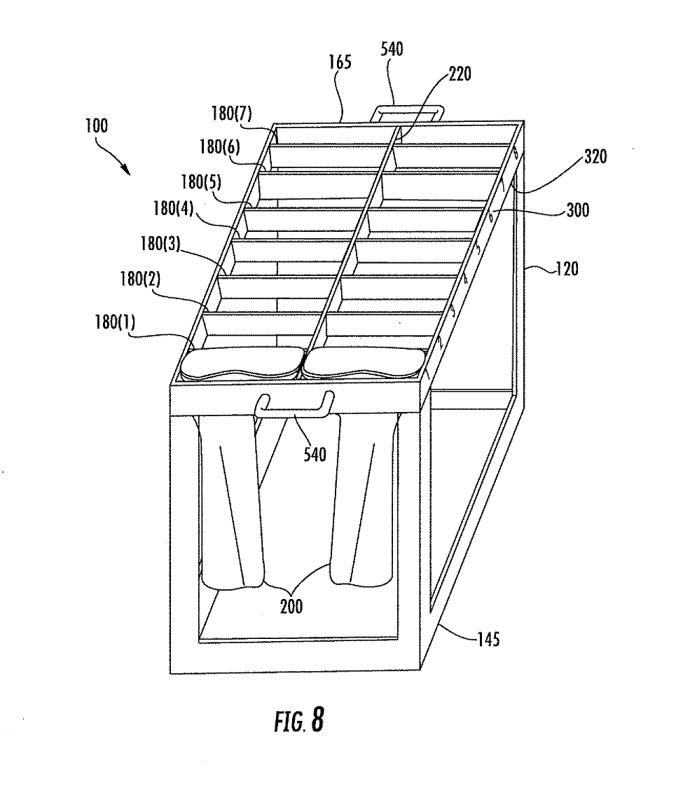

Referring now to FIGS. 7 and 8, another embodiment of the boot holder assembly 100 comprises a rectangular-shaped frame 120 having a bottom surface 145 and a top surface 165. The bottom surface 145 is for resting on the bed area 140 of the pick-up truck 160, for example. The top surface 165 comprises a plurality of spaced apart boot dividers 180(1)-180(7) extending between two opposite sides. The boot dividers 180(1)-180(7) are spaced apart such that when the top part of a pair of rubber boots 200 is inserted between any two dividers, the boots slide down so that the width of each boot is wider than the gap between the two dividers. This causes the rubber boots 200 to be held in an upside down position.

The boot holder device 100 thus provides a low profile and convenient method for storing and transporting rubber boots 200 in the bed area of a work truck 160. This is particularly advantageous after the rubber boots 200 have been used at the job site, and they have been hosed down with a water hose before being placed back in the bed area 140 of the work truck 160. When the rubber boots 200 are in the upside down position, rain, water and debris cannot get into the interior of the boot. Positioning of the boot holder device 100 in the bed area 140 of the work truck also allows for easy storage and retrieval of the boots 200 while standing on the ground outside of the truck.

In the illustrated example, 8 pairs of boots 200 may be held by the boot holder assembly 100. A support or divider bar 220 extends perpendicular to the spaced apart boot dividers 180(1)-180(7). The frame 120 may be constructed out of metal or plastic, for example. In one embodiment, the frame 120 measures 18×18×18 inches.

The boot holder assembly 100 may further comprise indicia 300 for labeling the work boots 200 when placed in the boot holder device. This advantageously allows each worker to keep track of their work boots 200 when there are several pairs of similarly looking boots being held by the boot holder device 10. The indicia 300 may be in the form of a strip 320 that extends along the side of the frame 120. The indicia 300 may include numbers and/or letters, for example. Alternatively, the strip 320 may extend along the divider bar 220.

At least one attachment device 500 may be used for attaching the frame 120 in the bed area 140 of the work truck 160. In one embodiment, the at least one attachment device comprises two pairs of tie down straps 500. The tie down straps 500 may loop around the bottom surface 145 of the frame 120 and are attached to the bed area 140 using screws 520, for example. The straps 500 may be Velcro straps so that the boot holder device 100 can be removed from the bed area 140 of the work truck 160 while the straps are still attached to the bed area via the screws 520. Alternatively, the tie down straps 500 may be attached to a sidewall of the bed area 140. To assist in moving the boot holder device 100 to/from the work truck 160, a pair of handles 540 is attached to the frame 120.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed:

1. A boot holder assembly to be secured to a tool box in the bed area of a truck, and comprising:
a mounting plate to be positioned on an outer surface of the tool box, and including a plurality of openings extending therethrough;
a reinforcement plate to be positioned on an inner surface of the tool box, and including a plurality of openings therein;
a plurality of fasteners for securing said mounting plate and said reinforcement plate to the tool box via the plurality of respective openings, with each fastener comprising a shoulder extending outwardly from said mounting plate; and
a removable rack comprising a base plate with a plurality of slotted openings extending therethrough, said base plate to be slideably positioned adjacent said mounting plate so that the plurality of slotted openings rest on the shoulders of said plurality of fasteners.

2. A boot holder assembly according to claim 1 wherein said removable rack comprises a plurality of spaced apart dividers extending outwardly from said base plate, with each pair of adjacent dividers for receiving a boot.

3. A boot holder assembly according to claim 2 wherein a spacing between each pair of adjacent dividers is less than a width of the received boot.

4. A boot holder assembly according to claim 2 wherein said removable rack further comprises a cross member coupled to ends of said plurality of spaced apart dividers, with each boot being received so that a heel area thereof is adjacent said base plate and a toe area thereof rests on said cross member.

5. A boot holder assembly according to claim 1 wherein each fastener further comprises a head adjacent the shoulder, with the head being larger than the shoulder; and wherein each slotted opening extending through said base plate includes a first opening portion for receiving the head of a fastener, and a second slotted opening portion for being slideably positioned on the shoulder of the fastener, with a width of the second slotted opening portion being less than a width of the first opening portion.

6. A boot holder assembly according to claim 1 wherein said plurality of fasteners comprise a plurality of threaded fasteners; and wherein the plurality of openings in said reinforcement plate is threaded for receiving the plurality of threaded fasteners.

7. A boot holder assembly according to claim 1 wherein said plurality of fasteners comprise a plurality of threaded fasteners, and a plurality of threaded nuts; and wherein the plurality of openings in said reinforcement plate extend therethrough for receiving the plurality of threaded fasteners, with said plurality of threaded nuts for securing said plurality of fasteners.

8. A boot holder assembly for a truck comprising:
a mounting plate to be positioned on an outer surface of a mounting area of the truck and including a plurality of openings extending therethrough;
a reinforcement plate to be positioned on an inner surface of the mounting area of the truck and including a plurality of openings therein;
a plurality of fasteners for securing said mounting plate and said reinforcement plate to the mounting area of the truck via the plurality of respective openings, with each fastener comprising a shoulder extending outwardly from said mounting plate; and
a removable rack comprising a base plate with a plurality of slotted openings extending therethrough, said base plate to be slideably positioned adjacent said mounting plate so that the plurality of slotted openings rest on the shoulders of said plurality of fasteners.

9. A boot holder assembly according to claim 8 wherein said removable rack comprises a plurality of spaced apart dividers extending outwardly from said base plate, with each pair of adjacent dividers for receiving a boot.

10. A boot holder assembly according to claim 9 wherein a spacing between each pair of adjacent dividers is less than a width of the received boot.

11. A boot holder assembly according to claim 9 wherein said removable rack further comprises a cross member coupled to ends of said plurality of spaced apart dividers, with each boot being received so that a heel area thereof is adjacent said base plate and a toe area thereof rests on said cross member.

12. A boot holder assembly according to claim 8 wherein each fastener further comprises a head adjacent the shoulder, with the head being larger than the shoulder; and wherein each slotted opening extending through said base plate includes a first opening portion for receiving the head of a fastener, and a second slotted opening portion for being slideably positioned on the shoulder of the fastener, with a width of the second slotted opening portion being less than a width of the first opening portion.

13. A boot holder assembly according to claim 8 wherein said plurality of fasteners comprise a plurality of threaded fasteners; and wherein the plurality of openings in said reinforcement plate is threaded for receiving the plurality of threaded fasteners.

14. A boot holder assembly according to claim 8 wherein said plurality of fasteners comprise a plurality of threaded fasteners, and a plurality of threaded nuts; and wherein the plurality of openings in said reinforcement plate extend therethrough for receiving the plurality of threaded fasteners, with said plurality of threaded nuts for securing said plurality of fasteners.

15. A method for storing boots in the bed area of a truck using a boot holder assembly comprising a mounting plate, a reinforcement plate, a plurality of fasteners and a removable rack, the method comprising:
positioning the mounting plate on an outer surface of a tool box in the bed area of the truck, the mounting plate including a plurality of openings extending therethrough;
positioning the reinforcement plate on an inner surface of the tool box, the reinforcement plate including a plurality of openings therein;
securing the mounting plate and the reinforcement plate to the tool box via the plurality of respective openings, with each fastener comprising a shoulder extending outwardly from the mounting plate; and
slideably positioning the removable rack adjacent the mounting plate, the removable rack comprising a base plate with a plurality of slotted openings extending therethrough, with the base plate being slideably positioned so that the plurality of slotted openings rest on the shoulders of the plurality of fasteners.

16. A method according to claim 15 wherein the removable rack comprises a plurality of spaced apart dividers extending outwardly from the base plate, with each pair of adjacent dividers for receiving a boot.

17. A method according to claim 16 wherein a spacing between each pair of adjacent dividers is less than a width of the received boot.

18. A method according to claim 16 wherein the removable rack further comprises a cross member coupled to ends of the plurality of spaced apart dividers, with each boot being received so that a heel area thereof is adjacent the base plate and a toe area thereof rests on the cross member.

19. A method according to claim 15 wherein each fastener further comprises a head adjacent the shoulder, with the head being larger than the shoulder; and wherein each slotted opening extending through the base plate includes a first opening portion for receiving the head of a fastener, and a second slotted opening portion for being slideably positioned on the shoulder of the fastener, with a width of the second slotted opening portion being less than a width of the first opening portion.

20. A method according to claim 15 wherein the plurality of fasteners comprise a plurality of threaded fasteners; and wherein the plurality of openings in the reinforcement plate is threaded for receiving the plurality of threaded fasteners.

21. A method according to claim 15 wherein the plurality of fasteners comprise a plurality of threaded fasteners, and a plurality of threaded nuts; and wherein the plurality of openings in the reinforcement plate extend therethrough for receiving the plurality of threaded fasteners, with the plurality of threaded nuts for securing the plurality of fasteners.
